(19) United States
(12) Patent Application Publication
(10) Pub. No.: US 2007/0131191 A1
(43) Pub. Date: Jun. 14, 2007

(54) Connecting rod with offset joint for an internal combustion engine

(75) Inventors: Richard Theodore Hurban, Cedar Falls, IA (US); Michael Alan Langner, Waterloo, IA (US); Dylan Frederick Foglesong, Black Mountain, NC (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/299,491

(22) Filed: Dec. 12, 2005

(51) Int. Cl. F02F 3/00

(52) U.S. Cl. 123/193.4

(57) ABSTRACT

A connecting rod for interconnecting a crankshaft with a piston in an internal combustion engine includes a cap connected to a rod and defining a crankshaft bore therebetween. The crankshaft bore includes an axis of rotation. The cap includes a first end defining a first split line and a second end defining a second split line. The first split line and the second split line are offset relative to a plane extending through the axis of rotation.

### FIELD OF THE INVENTION

The present invention relates to internal combustion engines, and, more particularly, to a connecting rod for interconnecting a crankshaft with a piston.

### BACKGROUND OF THE INVENTION

An internal combustion (IC) engine typically includes a block with a plurality of pistons reciprocally disposed within a plurality of corresponding combustion cylinders. Each piston is connected via a connecting rod with a crankshaft which provides mechanical output power from the IC engine. For interconnecting with the crankshaft, the connecting rod includes a cap connected with a rod. The cap may be machined separate from and attached to the rod, or formed integral with and separated (e.g., fractured) from the rod.

Connecting rods are also used in other applications including a reciprocating piston connected with a crankshaft. For example, connecting rods are also used in compressor applications.

Currently there are two types of connecting rod joint designs between the cap and rod: those with a 90 degree orientation between the longitudinal axis of the rod and the separating plane of the cap, and those with a 45 degree orientation between the longitudinal axis of the rod and the separating plane of the cap. Both designs are used for a variety of reasons to do with design and assembly considerations. The use of a 45 degree joint is primarily for assembly when the cylinder bore is smaller than the connecting rod width. Connecting rod bearing halves are installed in the cap and rod such that the split line between bearing halves is the same as the split line between the cap and rod. With the highly loaded area of a connecting rod in the axis of the rod and on 45 degree designs, the bearing joint is near the area of high load. Engine bearings worked well prior to emission regulations when the peak loading occurred in a location near the axis of the connecting rod but away from the joint. However, recent emissions laws have resulted in delayed peak loading so that it now occurs much closer to the bearing joint. Engine testing has demonstrated that loading can occur even beyond the joint line resulting in poor bearing performance. Contemplated solutions to this problem, such as reversing the installation of the connecting rod assembly in the machine, may require complete redesign of cylinder blocks and assembly tooling.

What is needed in the art is a connecting rod with reduced loading in the area of the split line between the cap and rod, while maintaining ease of manufacture and assembly.

### SUMMARY OF THE INVENTION

The present invention provides a connecting rod with a joint between the cap and rod having offset split lines.

The invention comprises, in one form thereof, a connecting rod for interconnecting a crankshaft with a piston in an internal combustion engine. The connecting rod includes a cap connected to a rod and defining a crankshaft bore therebetween. The crankshaft bore includes an axis of rotation. The cap includes a first end defining a first split line and a second end defining a second split line. The first split line and the second split line are offset relative to a plane extending through the axis of rotation.

The invention comprises, in another form thereof, an internal combustion engine including a block with at least one combustion cylinder, at least one piston, a crankshaft, and at least one connecting rod. Each piston is reciprocally disposed within a corresponding combustion cylinder. Each connecting rod interconnects the crankshaft with a corresponding piston. Each connecting rod includes a cap with a first end and a second end. The first end defines a first split line and the second end defines a second split line. The first split line and the second split line are substantially parallel and non-coplanar relative to each other.

### BRIEF DESCRIPTION OF THE DRAWINGS

FIG. 1 is a schematic, sectional view of a portion an internal combustion engine including an embodiment of a connecting rod of the present invention.

FIG. 2 is a side view of the connecting rod shown in FIG. 1.

FIG. 3 is another side view of the connecting rod shown in FIGS. 1 and 2.

FIG. 4 is a side view of another embodiment of a connecting rod of the present invention.

### DESCRIPTION OF THE PREFERRED EMBODIMENT

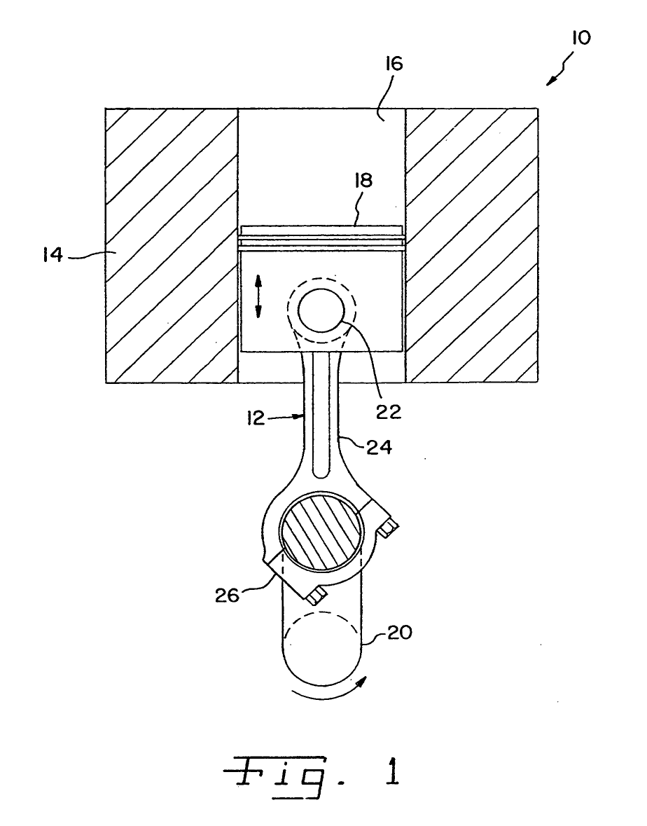

Referring now to the drawings, and more particularly to FIG. 1, there is shown an IC engine 10 including an embodiment of a connecting rod 12 of the present invention. IC engine 10 also includes a block 14 having one or more combustion cylinders 16. In the embodiment shown, block 14 is shown with a single combustion cylinder 16 for simplicity sake, but typically includes a plurality of combustion cylinders. IC engine 10 also includes one or more pistons 18 corresponding to the number of combustion cylinders. Each piston 18 is reciprocally disposed within a corresponding combustion cylinder 16. IC engine 10 also includes a crankshaft 20 which rotates as indicated. Connecting rod 12 interconnects crankshaft 20 with a corresponding piston 18 via a piston pin 22. Rotation of crankshaft 20 causes reciprocating movement of piston 18 within combustion cylinder 16.

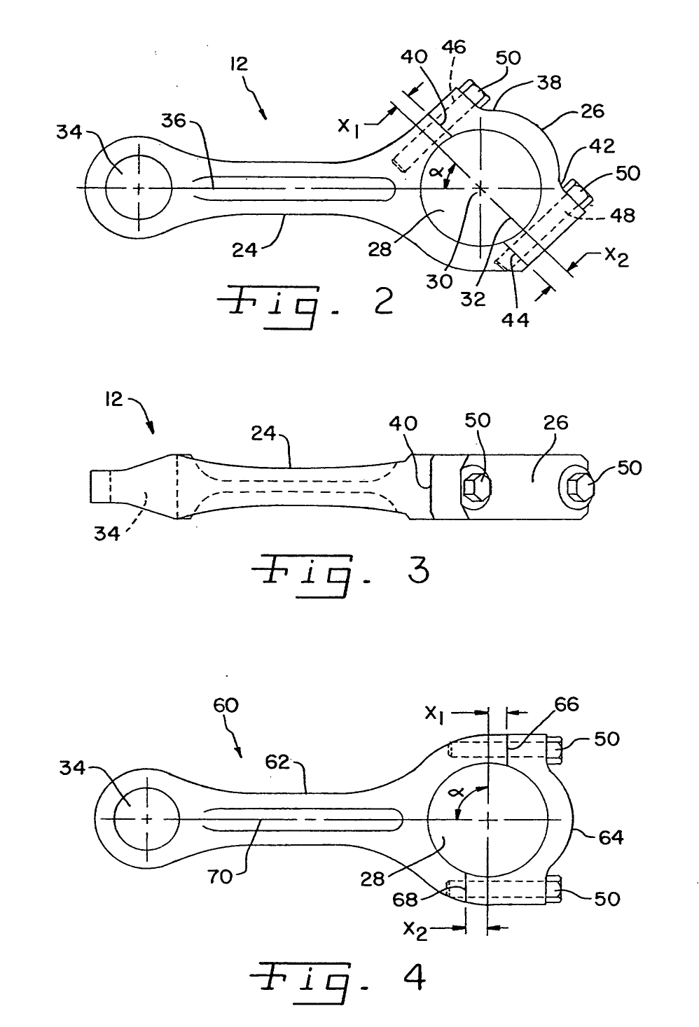

Referring now to FIGS. 2 and 3, connecting rod 12 is shown and will be described in greater detail. Connecting rod 12 generally includes a rod 24 and a cap 26. Rod 24 and cap 26 define a crankshaft bore 28 therebetween. Crankshaft bore 28 includes an axis of rotation 30, and a plane 32 is defined as extending through axis of rotation 30. Rod 24 includes a piston pin bore 34 at an end opposite from crankshaft bore 28. Rod 24 also includes a longitudinal axis 36. In the embodiment shown in FIGS. 1-3, longitudinal axis 36 and plane 32 are at an acute angle a relative to each other, and more particularly at a 450 angle relative to each other.

Cap 26 includes a first end 38 defining a first split line 40, and a second end 42 defining a second split line 44. First split line 40 and second split line 44 are substantially parallel and non-coplanar relative to each other. More particularly, first split line 40 and second split line 44 are offset from either side of plane 32 a distance X1 and X2, respectively. In the embodiment shown, first split line 40 and second split line 44 are offset a substantially same distance (e.g., 10 mm) from plane 32. It is also possible that first split line 40 and second split line 44 can be offset different distances from plane 32. Moreover, it is also contemplated that first split line 40 and second split line 44 can be slightly non-parallel to each other.

First end 38 includes a first fastener bore 46 and second end 42 includes a second fastener bore 48, each of which receives a cap screw 50 which threadingly engages a female threaded opening (not numbered) in the mating end of rod 24. First fastener bore 46 and second fastener bore 48 are substantially parallel to each other and substantially perpendicular to plane 32.

Referring now to FIG. 4, there is shown another embodiment of a connecting rod 60 of the present invention. Connecting rod 60 is substantially the same as connecting rod 12 shown and described above, and includes a rod 62 and cap 64 with offset split lines 66 and 68 therebetween. The primary difference between connecting rod 60 and connecting rod 12 is that split lines 66 and 68 are substantially perpendicular to longitudinal axis 70 of rod 62.

According to the present invention, connecting rods 12 and 60 position the split lines between the cap and rod away from the areas of high mechanical loading. This results in an improved oil film, decreased friction and reduced wear between the connecting rod and crankshaft.

Although the connecting rod of the present invention is shown and described above for use with an internal combustion engine, it is also to be understood that the connecting rod of the present invention may be used in other applications interconnecting a piston and crankshaft. For example, the connecting rod of the present invention may be used in compressor applications.

Having described the preferred embodiment, it will become apparent that various modifications can be made without departing from the scope of the invention as defined in the accompanying claims.

1. An internal combustion engine, comprising:
a block with at least one combustion cylinder;
at least one piston, each said piston reciprocally disposed within a corresponding said combustion cylinder;
a crankshaft; and
at least one connecting rod, each said connecting rod interconnecting said crankshaft with a corresponding said piston, each said connecting rod including a cap with a first end and a second end, said first end defining a first split line and said second end defining a second split line, said first split line and said second split line being substantially parallel and non-coplanar relative to each other.

2. The internal combustion engine of claim 1, each said connecting rod including a rod connected to said cap, said rod and said cap defining a crankshaft bore therebetween, said crankshaft bore including an axis of rotation and a plane extending through said axis of rotation

3. The internal combustion engine of claim 2, wherein said first split line, said second split line and said plane are all substantially parallel to each other.

4. The internal combustion engine of claim 3, wherein said first split line and said second split line are offset a substantially same distance from said plane.

5. The internal combustion engine of claim 2, wherein said first end includes a first fastener bore and said second end includes a second fastener bore, said first fastener bore and said second fastener bore being substantially parallel to each other and substantially perpendicular to said plane.

6. The internal combustion engine of claim 2, wherein said rod includes a longitudinal axis, said plane being substantially perpendicular to said longitudinal axis.

7. The internal combustion engine of claim 2, wherein said rod includes a longitudinal axis, said plane being at an acute angle relative to said longitudinal axis.

8. The internal combustion engine of claim 7, wherein said acute angle is approximately 45°.

9. A connecting rod for interconnecting a crankshaft with a piston, comprising:
a rod; and
a cap connected to said rod and defining a crankshaft bore therebetween, said crankshaft bore including an axis of rotation, said cap including a first end defining a first split line and a second end defining a second split line, said first split line and said second split line being offset relative to a plane extending through said axis of rotation.

10. The connecting rod of claim 9, wherein said first split line and said second split line are substantially parallel to each other.

11. The connecting rod of claim 10, wherein said first split line, said second split line and said plane are all substantially parallel to each other.

12. The connecting rod of claim 9, wherein said first split line and said second split line are offset a substantially same distance from said plane.

13. The connecting rod of claim 9, wherein said first end includes a first fastener bore and said second end includes a second fastener bore, said first fastener bore and said second fastener bore being substantially parallel to each other and substantially perpendicular to said plane.

14. The connecting rod of claim 9, wherein said rod includes a longitudinal axis, said plane being substantially perpendicular to said longitudinal axis.

15. The connecting rod of claim 9, wherein said rod includes a longitudinal axis, said plane being at an acute angle relative to said longitudinal axis.

16. The connecting rod of claim 15, wherein said acute angle is approximately 45°.

17. A connecting rod for interconnecting a crankshaft with a piston, comprising:
a cap with a first end and a second end, said first end defining a first split line and said second end defining a second split line, said first split line and said second split line being substantially parallel and non-coplanar relative to each other.

18. The connecting rod of claim 17, wherein said first end includes a first fastener bore and said second end includes a second fastener bore, said first fastener bore and said second fastener bore being substantially parallel to each other.

19. The connecting rod of claim 17, wherein said rod includes a longitudinal axis, said first split line and said second split line being substantially perpendicular to said longitudinal axis.

20. The connecting rod of claim 17, wherein said rod includes a longitudinal axis, said first split line and said second split line being at an acute angle relative to said longitudinal axis.

21. The connecting rod of claim 20, wherein said acute angle is approximately 45°.
